(19) United States
(12) Patent Application Publication
(10) Pub. No.: US 2012/0162382 A1
(43) Pub. Date: Jun. 28, 2012

(54) IMAGING CONTROL DEVICE, IMAGING CONTROL METHOD, IMAGING CONTROL PROGRAM, AND IMAGING APPARATUS

(75) Inventors: Shoei Hirasawa, Tokyo (JP); Keisuke Nakajima, Kanagawa (JP)

(73) Assignee: Sony Corporation, Tokyo (JP)

(21) Appl. No.: 13/331,195

(22) Filed: Dec. 20, 2011

(30) Foreign Application Priority Data
Dec. 28, 2010 (JP) 2010-293358

(51) Int. Cl. H04N 13/02

(52) U.S. Cl. 348/47; 348/E13.074

(57) ABSTRACT

An imaging control device controlling first and second imaging sections each generating an imaging signal based on an imaging light incident thereon using an imaging device and each having a filter for reducing the amount of the imaging light, includes: a filter driving control section controlling filter driving sections configured to insert or remove the filters, respectively, into and from the optical path of the imaging light such that the filter driving section performs the filter inserting or removing operation over a predetermined period of operation; and an amplification gain control section acting on signal processing sections configured to amplify the imaging signals, respectively, such that the gain of amplification of the imaging signal is controlled by a width of adjustment according to a difference between the amounts of light reduced by the filters of the imaging sections in conjunction with the operation of inserting or removing the filters.

### FIELD

The present disclosure relates to an imaging control device, an imaging control method, an imaging control program, and an imaging apparatus which are advantageously used in, for example, a compound eye imaging for performing stereoscopic imaging using two cameras.

### BACKGROUND

Methods of presenting a stereoscopic view of an object by allowing images of the object obtained from two viewpoints of left and right viewpoints (stereoscopic images) to be viewed by left and right eyes respectively have recently been proposed.

One known method of generating video signals to be used to present a stereoscopic view of an object as thus described is compound eye imaging for imaging an object from images of the object taken from two viewpoints using two cameras disposed left and right with respect to the object.

Two cameras used for compound eye imaging are similar to cameras performing ordinary imaging in that exposure control such as diaphragm control and shutter speed control can be exercised to adjust the brightness of an image generated by each of the cameras properly.

Particularly, in an compound eye imaging system for performing compound eye imaging, exposure control such as diaphragm control and shutter speed control of two cameras of the system must be exercised such that the cameras cooperate properly to match left and right images in terms of brightness and the like and to thereby suppress an unnatural impression that the resultant image may give. There are proposed compound eye imaging apparatus which are improved in terms of anti-vibration control for correcting blurring of an image attributable to vibration which may occur, for example, when two cameras are used. Specifically, adjustment values for either camera are set in advance such that the characteristics of the camera will be adjusted to the characteristics of the other camera, whereby the cameras will be controlled to have substantially the same amount of residual blur (for example, see JP-A-2010-32969 (Patent Document 1) (FIG. 3)).

### SUMMARY

In some cameras, an ND (neutral density) filter is inserted or removed into or from the optical path of imaging light obtained through a lens to adjust the luminance of the imaging light.

Individual ND filters may be different from each other in terms of the amount of light reduced thereby for reasons associated with the manufacture of the filters.

Under the circumstance, when an ND filter is inserted into the optical path of each of two cameras in a compound eye imaging system, images obtained by the cameras may be different from each other in various characteristics such as brightness observed while the filters are being inserted and after the filters are inserted even if the filters are inserted and removed at the same timing.

When ND filters are inserted or removed during an imaging operation of a compound eye imaging system, a resultant video signal will have low quality when evaluated as a stereoscopic image. As a result, there is a problem in that a stereoscopic image obtained from the video signal may appear unnatural and unsatisfactorily stereoscopic for a viewer.

Under the circumstance, it is desirable to provide an imaging control device, an imaging control method, an imaging control program, and an imaging apparatus which allow video signals having uniform characteristics to be generated as a result of compound eye imaging.

An embodiment of the present disclosure is directed to an imaging control device, an imaging control method, and an imaging control program controlling each of filter driving sections of first and second imaging sections each generating an imaging signal based on an imaging light incident thereon using an imaging device and each having a filter for reducing the amount of the imaging light. The filter driving sections which insert or remove the respective filters into or from the optical path of the imaging light is controlled such that the filter inserting or removing operation is performed over a predetermined period of operation. Each of signal processing sections configured to amplify the imaging signals at the first and second imaging sections, respectively, are also controlled such that the gain of amplification of the imaging signal is controlled by a width of adjustment according to a difference between the amounts of light reduced by a plurality of the filters of a plurality of the imaging sections in conjunction with the operation of inserting or removing the filters.

According to the embodiment of the present disclosure, any difference between the amounts of light reduced by the filters of a plurality of the imaging sections can be cancelled by the gains of amplification of each of video signals during the period of operation of the filter inserting or removing operation. It is therefore possible to suppress variation between light reduction amounts associated with various video signals.

The imaging apparatus according to the embodiment of the present disclosure includes the first and second imaging sections each generating an imaging signal based on an imaging light incident thereon using the imaging device and each having a filter for attenuating the imaging light, a filter driving control section controlling each of the filter driving sections configured to insert or remove the filters of the first and second imaging sections, respectively, into and from the optical path of the imaging light such that the filter driving section performs the filter inserting or removing operation over a predetermined period of operation, and an amplification gain control section acting on each of the signal processing sections configured to amplify the imaging signals at the first and second imaging sections, respectively, such that the gain of amplification of the imaging signal is controlled by a width of adjustment according to a difference between the amounts of light reduced by a plurality of the filters of a plurality of the imaging sections in conjunction with the operation of inserting or removing the filters.

According to the embodiment of the present disclosure, any difference between the amounts of light reduced by the filters of a plurality of the imaging sections can be cancelled by the gains of amplification of each of video signals during the period of operation of the filter inserting or removing operation. It is therefore possible to suppress variation between light reduction amounts associated with various video signals.

According to the embodiment of the present disclosure, any difference between the amounts of light reduced by the filters of a plurality of the imaging sections can be cancelled by the gains of amplification of each of video signals during the period of operation of the filter inserting or removing operation. It is therefore possible to suppress variation between light reduction amounts associated with various video signals. The embodiment of the present disclosure makes it possible to provide an imaging control device, an imaging control method, an imaging control program, and an imaging apparatus which allow video signals having uniform characteristics to be generated as a result of compound eye imaging.

### BRIEF DESCRIPTION OF THE DRAWINGS

FIG. 1 is a schematic diagram showing an overall configuration of a compound eye imaging system according to a first embodiment of the present disclosure;

FIG. 2 is a schematic block diagram showing a functional configuration of a system controller;

FIGS. 3A and 3B are schematic program diagrams to be followed when single eye imaging is performed;

FIGS. 4A to 4H are schematic diagrams showing amounts of light reduced by various parts of imaging units and total amounts of light reduced in the units when performing single eye imaging;

FIG. 5 is a flow chart of a light reduction amount increase control routine to be executed when performing single eye imaging;

FIGS. 6A and 6B are schematic program diagrams to be followed when compound eye imaging according to the first embodiment of the present disclosure is performed;

FIGS. 7A to 4J are schematic diagrams showing amounts of light reduced by various parts of imaging units and total amounts of light reduced in the units when compound eye imaging according to the first embodiment of the present disclosure is performed;

FIG. 8 is a flow chart of a light reduction amount increase control routine to be executed by an imaging unit when performing compound eye imaging;

FIG. 9 is a schematic diagram showing an overall configuration of a compound eye imaging system according to a second embodiment of the present disclosure;

FIGS. 10A and 10B are schematic program diagrams to be followed when compound eye imaging according to the second embodiment of the present disclosure is performed;

FIGS. 11A to 11J are schematic diagrams showing amounts of light reduced by various parts of camera apparatus and total amounts of light reduced in the apparatus when compound eye imaging according to the second embodiment of the present disclosure is performed;

FIGS. 12A and 12B are schematic program diagrams to be followed when compound eye imaging according to another embodiment of the present disclosure is performed;

FIGS. 13A to 13J are schematic diagrams showing amounts of light reduced by various parts of camera apparatus and total amounts of light reduced in the apparatus when compound eye imaging according to another embodiment of the present disclosure is performed; and

FIGS. 14A and 14B are schematic program diagrams to be followed when compound eye imaging according to still another embodiment of the present disclosure is performed.

### DETAILED DESCRIPTION

Embodiments of the present disclosure will now be described with reference to the drawings. The following items will be described in the order listed.

1. First Embodiment (embodiment employing a separate system controller)

2. Embodiment (embodiment employing a system controller incorporated in a camera apparatus)

3. Other Embodiments

### 1. First Embodiment

### [1-1. Configuration of Compound Eye Imaging System]

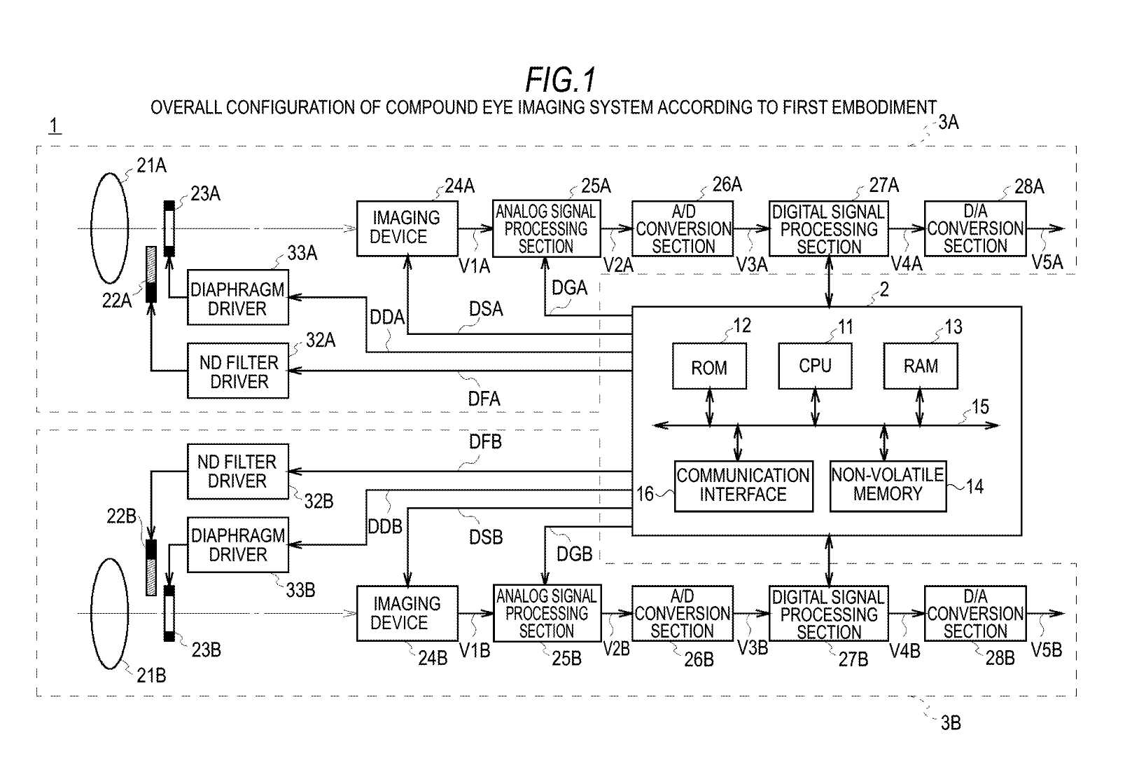

A compound eye imaging system 1 shown in FIG. 1 images a predetermined object on a compound eye basis with two imaging units 3A and 3B controlled by a system controller 2 to generate two systems of video signals forming a stereoscopic image of the object.

The system controller 2 includes a CPU (central processing unit) 11 performing various arithmetic processes as a primary element thereof, and a ROM (read only memory) 12, a RAM (random access memory) 13, and a non-volatile memory 14 are connected to the CPU through a bus 15.

The CPU 11 reads various programs such as a predetermined basic program and a light reduction amount control program from the ROM 12 and the non-volatile memory 14 and executes those programs using the RAM 13 as a work memory.

Various values to be used for controlling the imaging units 3A and 3B such as values of optical characteristics of ND filters used in the imaging units 3A and 3B respectively (the filters will be described later) are stored in the non-volatile memory 14.

The CPU 11 transmits various control signals to the imaging units 3A and 3B and acquires various pieces of information from various parts of the imaging units 3A and 3B through a communication interface (I/F) 16.

The imaging unit 3A images an object to be imaged (not shown) under control exercised by the system controller 2 to generate one system of video signals.

Specifically, the imaging unit 3A collects imaging light obtained from the object to be imaged with a lens 21A, reduces the amount of the imaging light with an ND filter 22A and a diaphragm 23A, and images the object with a CMOS imaging device 24A constituted by a CMOS (complementary metal oxide semiconductor).

The ND filter 22A is switchable in terms of whether it is used for imaging or not. Specifically, the filter is driven by an ND filter driver 32A to be inserted or removed into or from the optical path of the imaging light (represented by a chain line in the figure). The diaphragm 23A is driven by a diaphragm driver 33A to change the amount of imaging light stopped thereby.

The system controller 2 controls the operation of inserting or removing the ND filter 22A into and from the optical path of the imaging light through the ND filter driver 32A and also controls the amount of light stopped by the diaphragm 23A through the diaphragm driver 33A. Further, the system controller 2 controls the shutter speed of the imaging device 24A when imaging is performed. Hereinafter, the described control operations will be referred to as filter driving control, diaphragm control, and shutter speed control.

The imaging device 24A performs photoelectric conversion of the imaging light incident thereon through the diaphragm 23A to generate an analog video signal V1A and supplies the signal to an analog signal processing section 25A.

The analog signal processing section 25A amplifies the video signal V1A with an amplification gain under control exercised by the system controller 2 to generate a video signal V2A and supplies the signal to an A/D (analog-digital) conversion section 26A.

The A/D conversion section 26A performs analog-to-digital conversion of the analog video signal V2A to generate a digital video signal V3A and supplies the signal to a digital signal processing section 27A.

The digital signal processing section 27A performs various types of video signal processing such as a white balance correction process and a gamma correction process on the video signal V3A to generate a video signal V4A and supplies the signal to a D/A conversion section 28A. The D/A conversion section 28A performs digital-to-analog conversion of the digital video signal V4A to generate an analog video signal V5A and outputs the signal.

The digital signal processing section 27A performs predetermined arithmetic processes on each of pixel values constituting the video signal V3A or V4A to calculate various values representing the brightness and the like of the video signal V3A or V4A and supplies such values to the system controller 2. The system controller 2 adjusts control amounts to be used for various types of control such as filter driving control, diaphragm control, and shutter speed control such that an exposure value appropriate for the calculated values will be obtained.

The imaging unit 3A images an object to be imaged in the same manner as imaging by a common video camera under control exercised by the system controller 2 as thus described to generate a video signal V5A. The process performed by the imaging unit 3A to generate a video signal V5A associated with an object to be imaged under control exercised by the system controller 2 may be hereinafter referred to as “single eye imaging”.

The imaging unit 3B is similar in configuration to the imaging unit 3A. Under control exercised by the system controller 2, the imaging unit 3B images an object to be imaged from a position and a direction which are slightly different from the position and direction in which the imaging unit 3A images the object, whereby a video signal V5B associated with the video signal V5A is generated.

At this time, the system controller 2 causes the various types of control such as filter driving control, diaphragm control, and shutter speed control to be exercised such that the imaging units 3A and 3B are controlled in conjunction with each other. Thus, compound imaging control is exercised to control light reduction amounts and various values associated with the video signals V5A and V5B in a harmonized manner.

The video signals V5A and V5B generated by the imaging units 3A and 3B as thus described represent stereoscopic images which are images to be viewed by the left and right eyes of a viewer, respectively.

As thus described, the system controller 2 of the compound eye imaging system 1 performs a compound eye imaging process such that the imaging units 3A and 3B are controlled in conjunction with each other to generate the respective video signals V5A and V5B representing stereoscopic images.

### [1-2. Functional Configuration of System Controller]

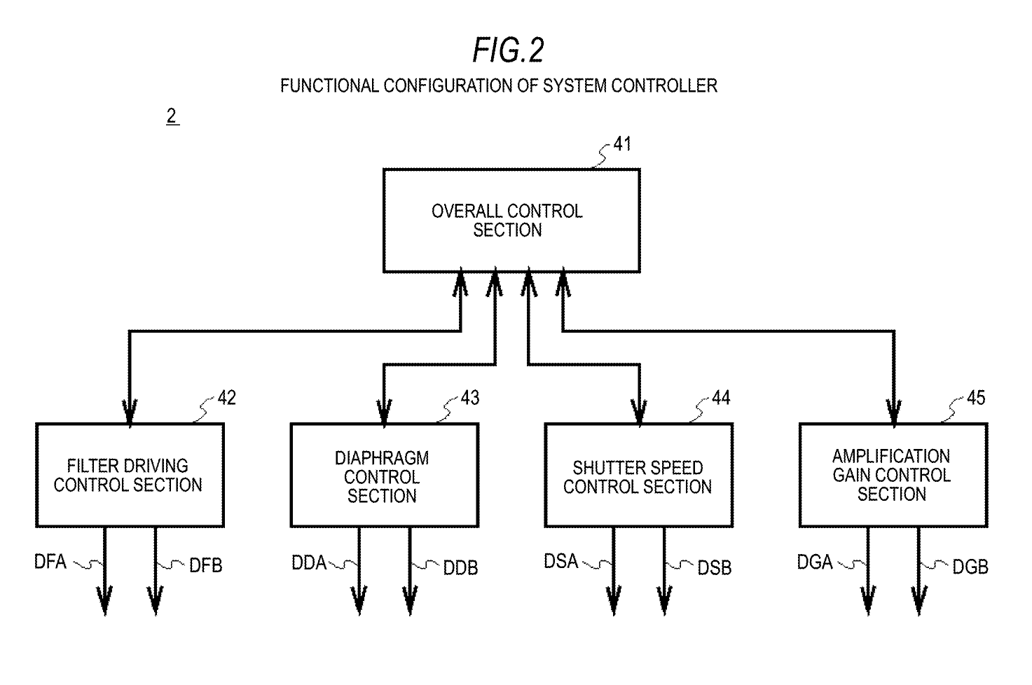

A functional configuration of the system controller 2 will now be described. When compound eye imaging is performed as described above, the system controller 2 reads and executes a predetermined light reduction amount control program, and a plurality of functional blocks as shown in FIG. 2 are consequently configured within the controller.

An overall control section 41 sets an exposure value of the compound eye imaging system 1 as a whole based on an operational instruction from an operating section which is not shown and values representing brightness and the like acquired from the digital signal processing sections 27A and 27B (FIG. 1).

Based on the exposure value thus set, the overall control section 41 subsequently decides whether to insert or remove the ND filters 22A and 22B and determines the aperture values of the diaphragms 23A and 23B, the shutter speeds of the imaging devices 24A and 24B, and gains of amplification at the analog signal processing sections 25A and 25B.

A filter driving control section 42 generates filter driving signals DFA and DFB for inserting or removing the ND filters 22A and 22B into or from the optical paths of the imaging light according to the decision made by the overall control section 41 on whether to insert or remove the filters. The signals are supplied to the ND filter drivers 32A and 32B (FIG. 1) respectively.

Upon receipt of the signals, the ND filter drivers 32A and 32B (FIG. 1) drive the ND filters 22A and 22B at timing and driving speeds based on the filter driving signals DFA and DFB.

A diaphragm control section 43 generates diaphragm driving signals DDA and DDB for driving the diaphragms 23A and 23B according to the aperture values determined by the overall control section 41 and supplies the signals to the diaphragm drivers 33A and 33B.

Upon receipt of the signals, the diaphragm drivers 33A and 33B (FIG. 1) drives the diaphragms 23A and 23B based on the diaphragm driving signals DDA and DDB.

A shutter speed control section 44 generates shutter speed signals DSA and DSB for setting the shutter speeds determined by the overall control section 41 in the imaging devices 24A and 24B and supplies the signals to the imaging devices 24A and 24B.

Upon receipt of the signals, the shutter speeds are set in the imaging devices 24A and 24B (FIG. 1) based on the shutter speed signals DSA and DSB.

An amplification gain control section 45 generates amplification gain signals DGA and DGB for setting the gains of amplification determined by the overall control section 41 in the analog signal processing sections 25A and 25B and supplies the signals to the analog signal processing sections 25A and 25B.

Upon receipt of the signals, the gains of amplification are set in the analog signal processing sections 25A and 25B (FIG. 1) based on the amplification gain signals DGA and DGB.

As thus described, the system controller 2 generates driving signals or the like in each of the functional blocks thereof according to an exposure value to be set and supplies the signals to the imaging units 3A and 3B to control amounts of light to be reduced associated with video signals V5A and V5B appropriately.

### [1-3. Control Over Amounts of Light Reduction]

When the system controller 2 adjusts amounts of light to be reduced associated with video signals V5A and V5B, the controller controls the amounts using combination of the shutter speeds of the imaging devices 24A and 24B, the amounts of light stopped by the diaphragms 23A and 23B, and the degrees of insertion of the ND filters 22A and 22B.

### [1-3-1. Control Over Amount of Light Reduction During Single Eye Imaging]

A description will now be made on adjustment of the amount of light to be reduced associated with a video signal V5A carried out by the system controller 2 when imaging is performed using the imaging unit 3A only or when a single eye imaging process is performed.

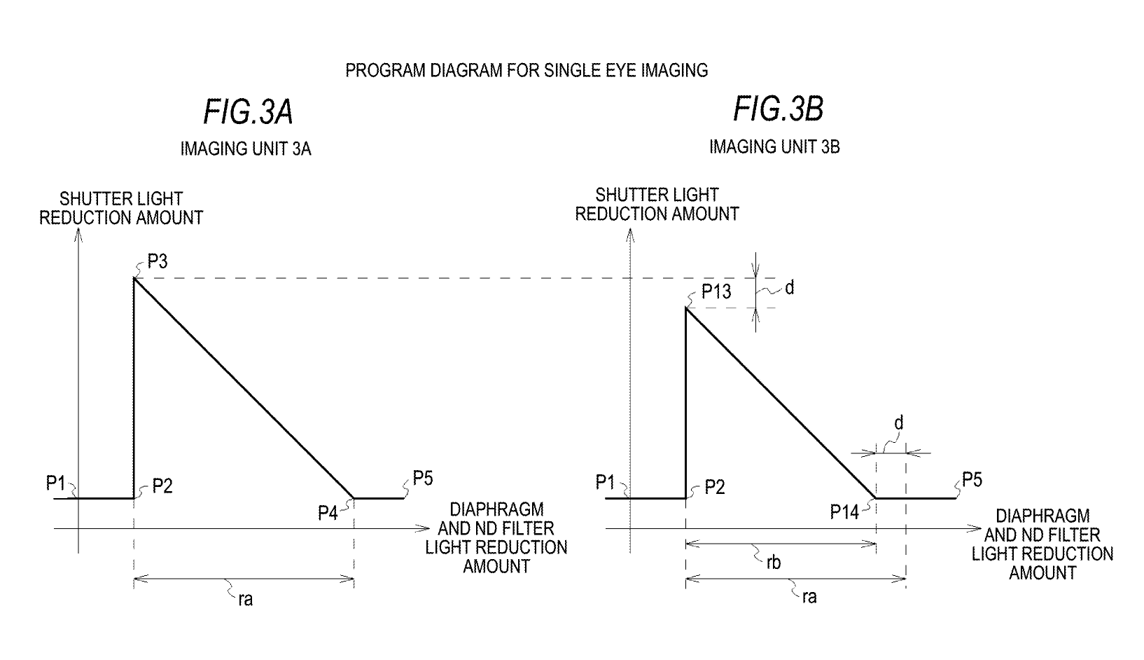

FIG. 3A is what is called a program diagram, and the figure represents how each control operation is carried out using a combination of the shutter speed of the imaging device 24A, the amount of light stopped by the diaphragm 23A, and the degree of insertion of the ND filter 22A in the form of a diagram.

The vertical axis of FIG. 3A represents the amount of light reduction determined by the shutter speed of the imaging device 24A (the amount may be hereinafter referred to as “shutter light reduction amount”). A point on the vertical axis represents the lower shutter speed of the imaging device 24A or the greater light reduction amount, the higher the point is located on the vertical axis.

The horizontal axis of FIG. 3A represents the sum of the amount of light reduced by the diaphragm 23A (the amount may be hereinafter referred to as “diaphragm light reduction amount”) and the amount of light reduced by the ND filter 22A (the amount may be hereinafter referred to as “ND filter light reduction amount”). The sum may be hereinafter referred to as “diaphragm/ND filter light reduction amount”. A point on the horizontal axis of FIG. 3A represents the greater aperture value of the diaphragm 23A and the higher degree of insertion of the ND filter 22A into the optical path of imaging light, the closer the point is located to the right end of the horizontal axis.

The sum of a value on the vertical axis of FIG. 3A and a value on the horizontal axis of the figure represents the sum of an amount of light reduction attributable to the shutter speed of the imaging device 24A, an amount of light reduced by the diaphragm 23A, and an amount of light reduced by the ND filter 22A. That is, the sum is a value representing the total amount of light reduced at the imaging unit 3A as a whole.

The interval between the points P2 and P4 in FIG. 3A represents a light reduction amount equivalent to an light reduction amount ra achieved by the ND filter 22A, and the interval between the points P2 and P3 also represents a light reduction amount equivalent to the light reduction amount ra.

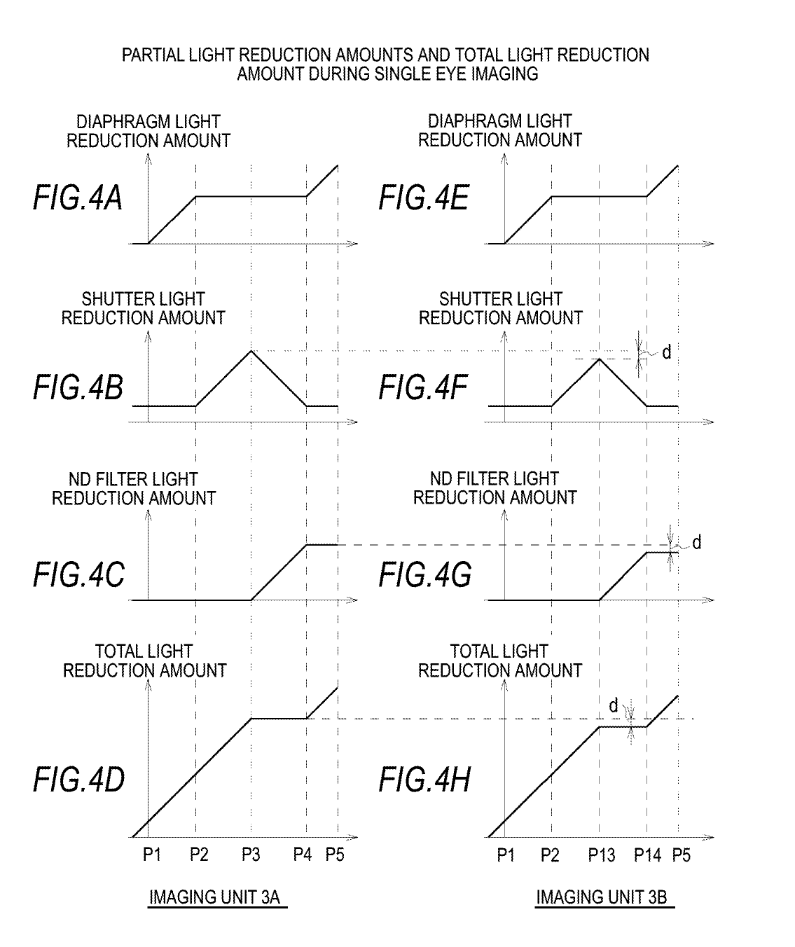

FIGS. 4A to 4D shows the shutter light reduction amount, the diaphragm light reduction amount, the ND filter light reduction amount, and the total light reduction amount, respectively, plotted in association with the points P1 to P5 shown in FIG. 3A.

A situation will now be discussed in which the quantity of imaging light must be reduced to cope with a great increase in the quantity of light such as when an object to be imaged moves from an in-door environment to out-door.

In general, imaging of an object is carried out with the light reduction amount changed as occasion demands such that the brightness of resultant images will stay within a desired range. The amount of light reduction is, however, continuously changed inmost cases because an image can appear uncomfortable for a viewer when it is imaged with the amount of light reduction changed abruptly.

For this reason, when the amount of light reduction associated with the video signal V5A is to be continuously increased, the system controller 2 controls the amount of light reduction at each part of the imaging device as shown in FIGS. 4A to 4B according to the program diagram shown in FIG. 3A.

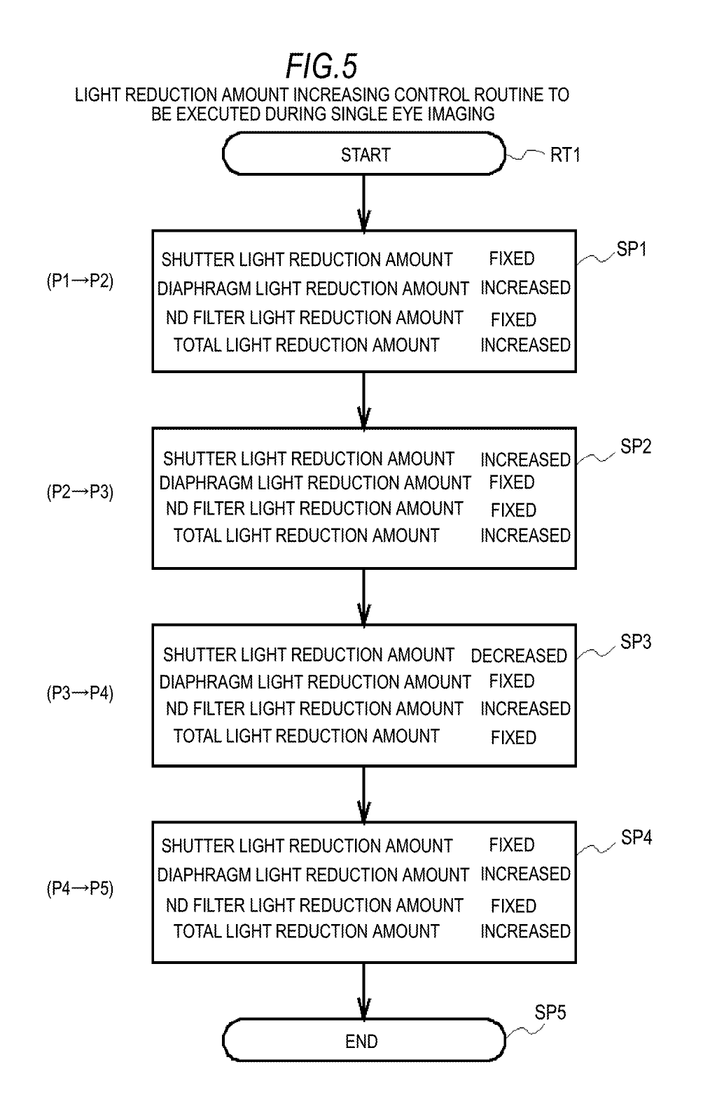

Specifically, the system controller 2 reads out and executes a light reduction amount control program for single eye imaging stored in advance in the non-volatile memory 14 (FIG. 1). Thus, the controller starts a light reduction amount increasing control routine RT1 as shown in FIG. 5 and enters step SP1 of the routine.

At step SP1, the system controller 2 increases the total amount of light reduction by increasing the amount of light reduced by the diaphragm with the amount of light reduced by the shutter and the amount of light reduced by the ND filter kept unchanged (FIGS. 4A and 4D). At this time, the system controller 2 moves from the point P1 to the point P2 on the program diagram, and the controller thereafter proceeds to step SP2.

At step SP2, the system controller 2 continues increasing the total amount of light reduction by increasing the amount of light reduced by the shutter with the amount of light reduced by the diaphragm and the amount of light reduced by the ND filter kept unchanged (FIGS. 4B and 4D). At this time, the system controller 2 moves from the point P2 to the point P3 on the program diagram, and the controller thereafter proceeds to step SP3.

At step SP3, the system controller 2 decreases the amount of light reduced by the shutter and increases the amount of light reduced by the ND filter with the amount of light reduced by the diaphragm kept unchanged (FIGS. 4B and 4C). In the meantime, the total amount of light reduction is kept unchanged (FIG. 4D). At this time, the system controller 2 moves from the point P3 to the point P4 on the program diagram, and the controller thereafter proceeds to step SP4.

That is, during the interval between the points P3 and P4 of the program diagram, the system controller 2 gradually replaces the amount of light reduced by the shutter with the amount of light reduced by the ND filter with the total amount of light reduction kept unchanged over a predetermined period of operation.

At step SP4, the system controller 2 increases the total amount of light reduction to a desired value by increasing the amount of light reduced by the diaphragm with the amount of light reduced by the shutter and the amount of light reduced by the ND filter kept unchanged just as done at step SP1 (FIGS. 4A and 4D). At this time, the system controller 2 moves from the point P4 to the point P5 on the program diagram, and the controller thereafter proceeds to step SP5.

At step SP5, the system controller terminates the light reduction amount increasing control routine RT1.

A description will now be made on the reason for the operation of temporarily increasing the amount of light reduced by the shutter during the interval between the points P2 and P3 of the program diagram of FIG. 3A and thereafter increasing the amount of light reduced by the ND filter with the amount of light reduced by the shutter decreased during the interval between the points P3 and P4.

Generally speaking, the ND filter 22A is a filter capable of reducing a certain amount of light. When ND filter 22A is inserted into the optical path of imaging light, the brightness of a video signal associated with the imaging light undergoes a significant change from the value thereof before the insertion of the filter. When such a significant change occurs in the video signal in a short time, a viewer may receive a very unnatural impression from the video signal.

When the ND filter 22A is inserted into the optical path relatively slowly (e.g., within a period of 1 to 2 sec.), the overall brightness of an image obtained from the video signal gradually changes, and a viewer will therefore receive a less unnatural impression from the image than an image obtained by inserting the filter in a short time.

Further, when the ND filter 22A is relatively slowly inserted into the optical path without a pause while decreasing the shutter speed gradually, the inserting operation can be completed with the total amount of light reduction kept constant and the unnatural impression given to a viewer can be suppressed significantly. In this case, it is possible to prevent the so-called half insertion of the ND filter from continuing, whereby the adverse effect of degradation of an MTF (modulation transfer function) can be minimized.

When the shutter speed is to be decreased, the shutter speed must be once increased in advance.

For such reasons, the system controller 2 controls the imaging unit 3A such that the amount of light reduction associated with the video signal V5A will follow the program diagram shown in FIG. 3A.

When the ND filter 22A is removed from the optical path of the imaging light to increase the amount of light reduction associated with the video signal V5A, the system controller 2 controls various parts of the imaging unit 3A such that the plot of the program diagram of FIG. 3A will be followed in reverse. In the case of single eye imaging, the system controller 2 causes the gain of amplification at the analog signal processing section 25A to be kept unchanged from a predetermined value.

### [1-3-2. Differences in Characteristics Between ND Filters and Differences Between Program Diagrams Thereof]

Some inevitable differences originating in manufacturing processes exist between the optical characteristics of the ND filter 22A of the imaging unit 3A and the ND filter 22B of the imaging unit 3B shown in FIG. 1 (specifically, a difference between the amounts of light reduced by those filters).

As a result, when the amount of light reduced by the ND filter 22B is smaller than the amount of light reduced by the ND filter 22A, there is a difference between the program diagrams associated with the filters shown in FIGS. 3A and 3B.

Referring to FIG. 3B, the program diagram of the ND filter 22B is in the form of a bent line extending through points P13 and P14 different from the points P3 and P4.

Specifically, a light reduction amount rb attributable to the ND filter 22B is smaller than the light reduction amount ra attributable to the ND filter 22A by a difference d. The difference between the amounts of light reduced by the ND filters is accompanied by a similar phenomenon. That is, the amount of light reduced by the shutter of the imaging unit 3B shown in the program diagram of FIG. 3B is smaller than the comparable amount of the imaging unit 3A shown in the program diagram of FIG. 3A by a difference d.

As will be apparent from FIGS. 4A to 4D and FIGS. 4E to 4H comparative to them, the imaging units 3A and 3B are different from each other in the amount of light reduced by the ND filter and the amount of light reduced by the shutter among the various amounts of light reduction associated with the imaging units.

For example, when the amount of light reduction associated with the video signal V5B is to be continuously increased, the system controller 2 controls the various amounts of light reduction associated with the imaging unit 3B as shown in FIGS. 4E to 4H according to the program diagram shown in FIG. 3B.

Therefore, if the system controller 2 exercises control to increase the amounts of light reduction associated with the imaging units 3A and 3B according to the respective program diagrams to achieve the same total amount of light reduction as a target value, the imaging units 3A and 3B may become different from each other in terms of the shutter speed, the amount of light stopped by the diaphragm, or the degree and timing of insertion or removal of the ND filter.

In such a case, left and right images generated from the video signals V5A and V5B may be different from each other in image quality because of differences between the shutter speeds and the depths of field associated with the signals. Therefore, when the left and right images are viewed by a viewer as a stereoscopic image, the image may have flickers or give an unnatural impression.

### [1-3-3. Control Over Amount of Light Reduction During Compound Eye Imaging]

When an amount of light reduction is to be controlled during compound eye imaging, the system controller 2 exercises control over the gain of amplification of the video signal in conjunction with addition to control over the shutter speed, the aperture value, and the insertion and removal of the ND filter as described above.

In the present embodiment, the system controller 2 controls to increase the gain of amplification at the analog signal processing section 25A of the imaging unit 3A whose ND filter reduces a greater amount of light.

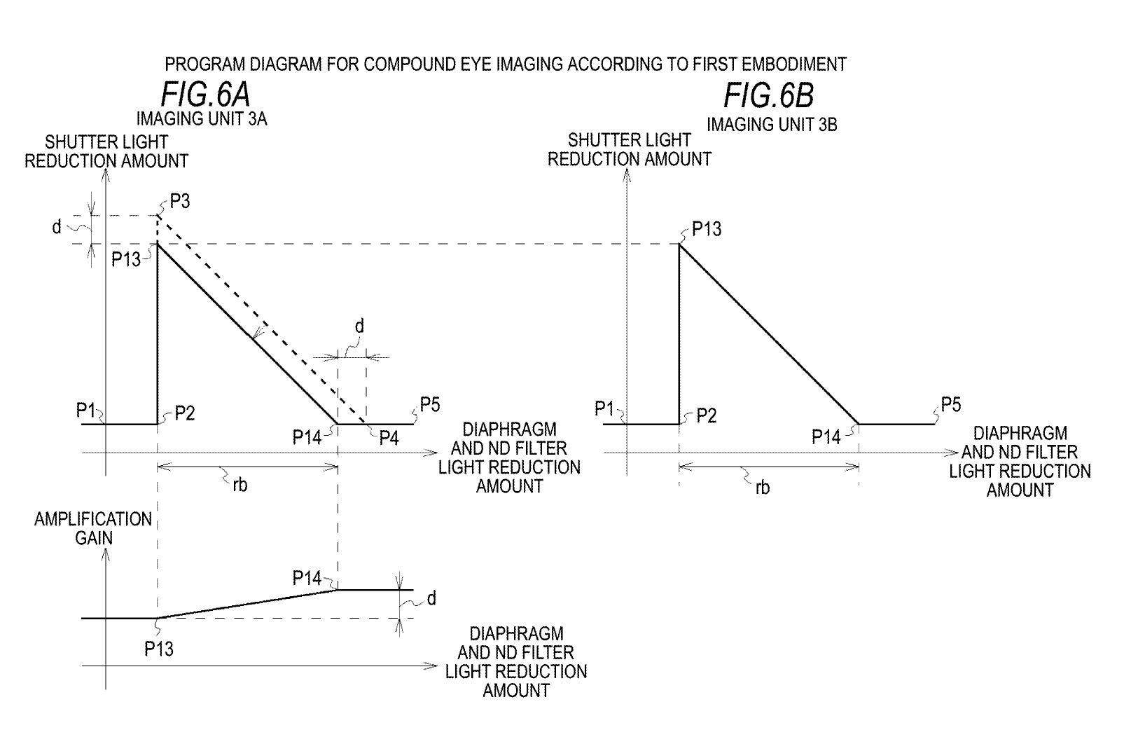

For this reason, a program diagram that the imaging unit 3A is to follow during compound eye imaging is corrected or adjusted to a program diagram of the imaging unit 3B, as shown in the top part of FIG. 6A which corresponds to FIG. 3A. Specifically, points P3 and P4 on the program diagram shown in the top part of FIG. 6A are moved to points P13 and P14, respectively.

As shown in the bottom part of FIG. 6A, the imaging unit 3A follows an additional program diagram which represents the gain of amplification at the analog signal processing section 25A. The vertical axis of the diagram shown in the lower part of FIG. 6A represents the gain of amplification. A point on the vertical axis represents the greater gain of amplification or the smaller amount of light reduction, the higher the point is located on the vertical axis.

The points P13 and P14 on the program diagram in the bottom part of FIG. 6A correspond to the points P13 and P14 on the program diagram in the top part of FIG. 6A, respectively. That is, when the ND filter 22A is gradually inserted into the optical path of the imaging light over a predetermined period of operation, the gain of amplification is controlled by gradually increasing the gain of amplification over the period of operation.

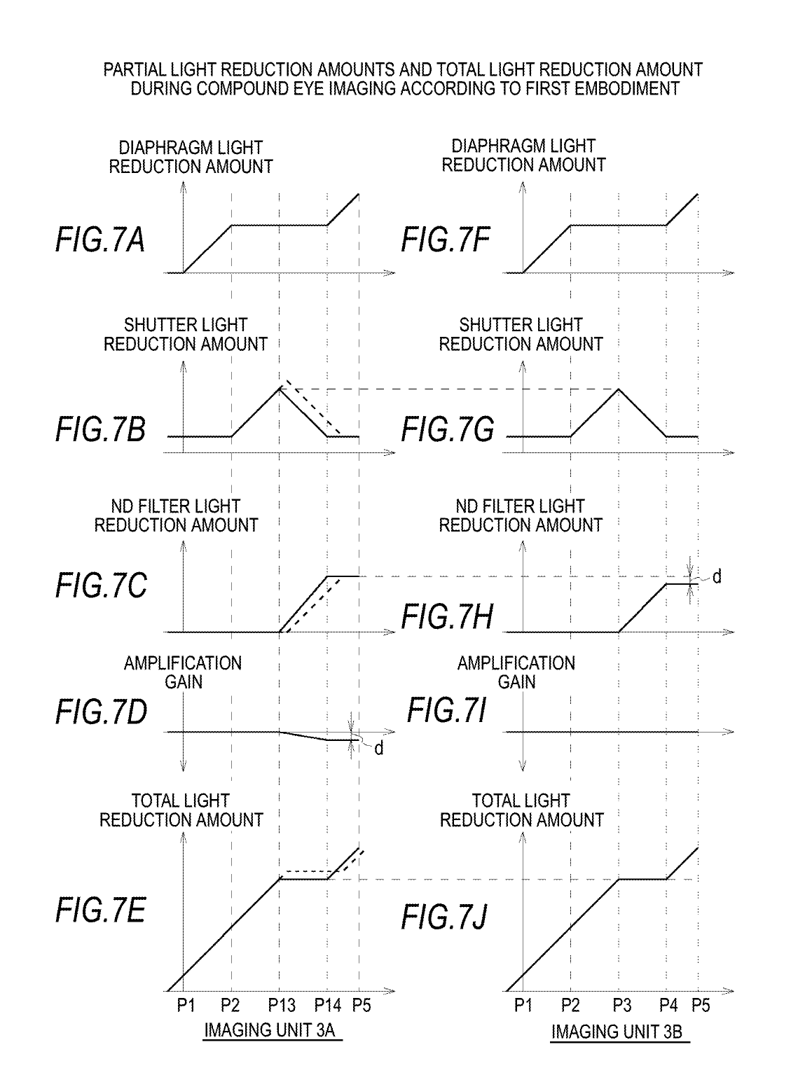

FIGS. 7A to 7E partially correspond to FIGS. 4A to 4D, and the figures show amounts of light reduced at the imaging unit 3A, i.e., amounts of light reduced by the shutter, the diaphragm, and the ND filter of the imaging unit, an amount of light reduction attributable to the gain of amplification, and a total amount of light reduction at the unit in association with points on the program diagram shown in FIG. 6A.

In FIGS. 7F to 7J, an amount of light reduction attributable to the gain of amplification at the imaging unit 3B is shown in addition to amounts of light reduced by various parts of the unit and a total amount of light reduction at the unit shown in FIGS. 4E to 4F.

The vertical axes of FIGS. 7D and 7I in the form of downward pointing arrows represent the gains of amplification. The figures are similar to FIGS. 7A, 7B, 7C, and 7E in that a point on either vertical axis represents the greater amount of light reduction, the higher the point is located on the vertical axis. Each of the thick broken lines in FIGS. 7B, 7C, and 7E represents an amount of light reduced during single eye imaging.

For example, when the amount of light reduction associated with the video signal V5A is continuously increased in practice, the various amounts of light reduction associated with the imaging unit 3A are controlled as shown in FIGS. 7A to 7E according to the program diagrams shown in FIG. 6A.

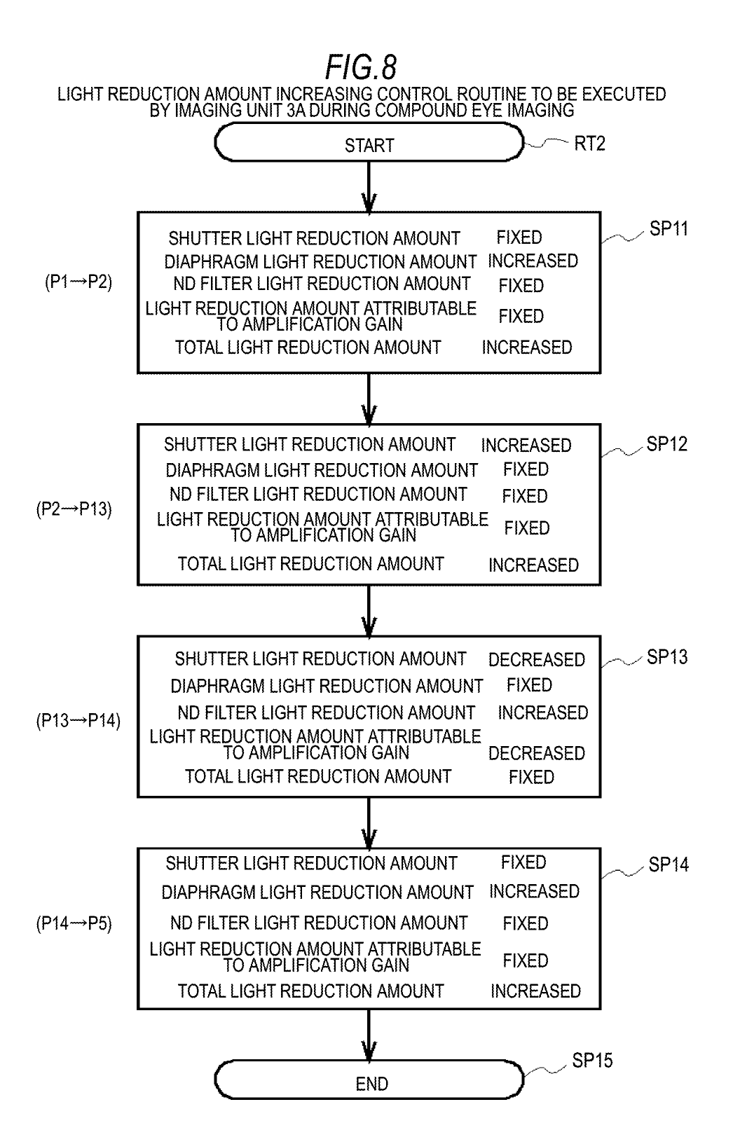

Specifically, the system controller 2 reads out and executes a light reduction amount control program for compound eye imaging stored in advance in the non-volatile memory 14 (FIG. 1). Thus, the controller starts a light reduction amount increasing control routine RT2 as shown in FIG. 8 which corresponds to FIG. 5 and enters step SP11 of the routine.

At step SP11, the system controller 2 increases the total amount of light reduction by increasing the amount of light reduced by the diaphragm with the amount of light reduced by the shutter and the amount of light reduced by the ND filter kept unchanged (FIGS. 7A and 7E) just as done at step SP1. At this time, the system controller 2 moves from the point P1 to the point P2 on the program diagram, and the controller thereafter proceeds to step SP12.

At step SP12, the system controller 2 continues increasing the total amount of light reduction by increasing the amount of light reduced by the shutter with the amount of light reduced by the diaphragm and the amount of light reduced by the ND filter kept unchanged (FIGS. 7B and 4E). At this time, the system controller 2 moves from the point P2 to the point P13 on the program diagram, and the controller thereafter proceeds to step SP13.

At step SP13, the system controller 2 increases the amount of light reduced by the ND filter while decreasing the amount of light reduced by the shutter with the amount of light reduced by the diaphragm fixed, and the controller further increases the gain of amplification (FIGS. 7B, 7C, and 7D). In the meantime, the total amount of light reduction is kept unchanged (FIG. 7E). At this time, the system controller 2 moves from the point P13 to the point P14 on the program diagram, and the controller thereafter proceeds to step SP14.

That is, during the interval between the points P13 and P14 of the program diagram, the system controller 2 gradually replaces the amount of light reduced by the shutter with the sum of the amount of light reduced by the ND filter and the amount of light reduction attributable to the gain of amplification with the total amount of light reduction kept unchanged over a predetermined period of operation.

At step SP14, the system controller 2 increases the total amount of light reduction to a desired value by increasing the amount of light reduced by the diaphragm with the amount of light reduced by the shutter and the amount of light reduced by the ND filter kept unchanged just as done at step SP11 (FIGS. 7A and 7E). At this time, the system controller 2 moves from the point P14 to the point P5 on the program diagram, and the controller thereafter proceeds to step SP15.

At step SP15, the system controller 2 terminates the light reduction amount increasing control routine RT2.

As thus described, the system controller 2 controls the imaging unit 3A such that the amount of light reduced by the shutter is adjusted to the comparable amount in the imaging unit 3B and such that an excess of the amount reduced by the ND filter of the unit 3A over the comparable amount of the imaging unit 3B (a difference d) is cancelled by the increase in the gain of amplification.

Thus, the system controller 2 can always adjust the total amount of light reduced at the imaging unit 3A to the comparable amount at the imaging unit 3B.

### [1-4. Operations and Effects]

When compound eye imaging is performed using the imaging units 3A and 3B in the above-described configuration, the system controller 2 of the compound eye imaging system 1 exercises control such that the imaging unit 3A whose ND filter reduces a greater amount of light is adjusted to the imaging unit 3B.

Specifically, the system controller 2 controls the amount of light reduced by the diaphragms 23A and the amount of light reduced by the shutter of the imaging device 24A such that they agree with comparable amounts at the imaging unit 3B according to the program diagram of the imaging unit 3A (FIG. 6A) corrected into agreement with the program diagram of the imaging unit 3B (FIGS. 7A, 7B, 7F, and 7G).

The system controller 2 exercises control for a predetermined period of operation such that the amount of light reduced by the ND filter 22A is gradually increased and such that the gain of amplification at the analog signal processing section 25A is gradually increased. That is, control is exercised such that the amount of light reduction attributable to the gain of amplification is gradually decreased (FIGS. 7C and 7D).

As a result, when increasing the amount of light reduction, the system controller 2 can make the total amounts of light reduction at the imaging units 3A and 3B equal to each other while making the shutter speeds and the aperture values of the imaging units completely equal to each other and also making the degrees of insertion of the ND filters 22A and 22B completely equal to each other.

In the case of a stereoscopic image, it is desirable in general that the right eye image and the left eye image are appropriately different from each other in terms of the position and angle of the object with respect to the background and that the images have the same brightness and the same depth of field.

Factors which can cause a change in the brightness of a video signal within an imaging unit include insertion or removal of an ND filter, a change in the aperture value, a change in the shutter speed, and adjustment of the gain of amplification.

In the case of compound eye imaging, a change in the aperture value and a change in the shutter speed can result in a difference in the depth of field and a difference in flickers between the left and right video signals. When ND filters are inserted or removed at different degrees and at different timing, resultant images will be different in quality and will therefore be likely to give an unnatural impression to a viewer. Adjustment of a gain of amplification results in a quite low level of degradation of image quality when compared to other factors, although the adjustment may result in deferent amounts of noise.

In the compound eye imaging system 1, the video signals V5A and V5B can be made equal to each other in terms of values representing various characteristics such as brightness by controlling the gains of amplification at the analog signal processing sections appropriately while minimizing degradation of image quality in spite of a difference between the amounts of light reduced by the ND filters. It is therefore possible to generate a stereoscopic image which gives no unnatural impression to a viewer.

In the present embodiment, the gain of amplification at the analog signal processing section 25A is corrected in the direction of increasing the same such that the imaging unit 3A whose ND filter reduces a greater amount of light will be adjusted to the imaging unit 3B. Since there is no concern that the gain of amplification at the analog signal processing section 25A of the compound eye imaging system 1 may fall below a minimum requirement, no degradation of image quality will occur for such a reason.

The system controller 2 follows a program diagram, including an additional part for controlling the gain of amplification to correct the imaging unit 3A according to the imaging unit 3B. There is no need for making a change in the basic rule that is followed when single eye imaging is performed, i.e., the rule of “determining the value of the controlled variable of each part according to a program diagram”.

That is, the compound eye imaging system 1 can perform single eye imaging and compound eye imaging with the difference between control methods used for the imaging modes minimized. The imaging unit 3A can be used as it is for compound eye imaging without adding components and/or making changes in the configuration thereof because it is required only to change the gain of amplification at the analog signal processing section 25A according to the control exercised by the system controller 2 whereas the gain is fixed in the case of single eye imaging.

In the above-described configuration, the system controller 2 of the compound eye imaging system 1 exercises control such that the amounts of light reduced by the diaphragm and the shutter of the imaging unit 3A whose ND filter reduces a greater amount of light are made equal to the comparable amounts of the imaging unit 3B according to a program diagram corrected as thus described. The system controller 2 exercises control such that the amount of light reduced by the ND filter 22A is gradually increased and such that the gain of amplification is gradually increased. As a result, when increasing the amount of light reduction, the system controller 2 can make the total amounts of light reduction at the imaging units 3A and 3B equal to each other while making the shutter speeds and the aperture values of the imaging units completely equal to each other and also making the degrees of insertion of the ND filters 22A and 22B completely equal to each other.

### 2. Second Embodiment

### [2-1. Configuration of Compound Eye Imaging System]

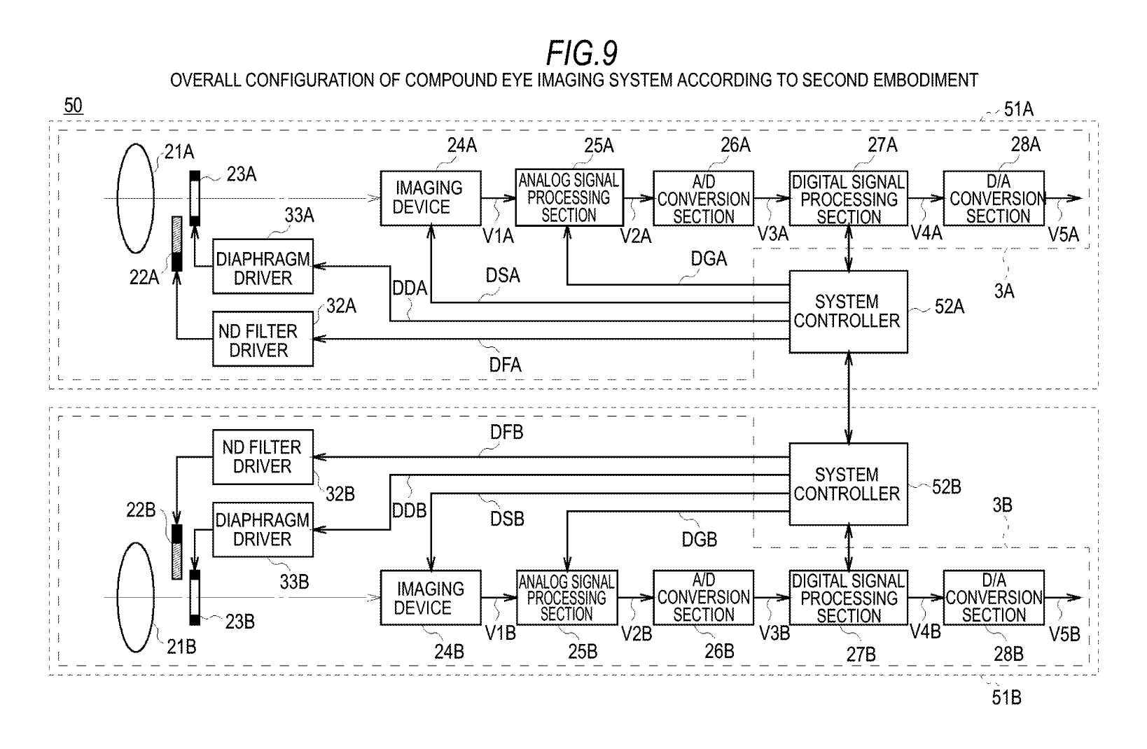

As shown in FIG. 9 in which an element corresponding to an identical element in FIG. 1 is indicated by a reference numeral identical between those figures, a compound eye imaging system 50 according to a second embodiment of the present disclosure performs a compound eye imaging process using two camera apparatus, i.e., camera apparatus 51A and 51B operating in conjunction with each other.

The camera apparatus 51A is similar in configuration to an imaginary unit formed by integrating the imaging unit 3A and the system controller 2 of the first embodiment. The entire apparatus is controlled as a whole by a system controller 52A corresponding to the system controller 2.

The system controller 52A is similar to the system controller 2 in hardware configuration (FIG. 1). Various values to be used for controlling various parts of the camera apparatus 51A such as values representing optical characteristics of an ND filter 22A are stored in a non-volatile memory (not shown) provided in the system controller 52A.

The camera apparatus 51B is similar to the camera apparatus 51A in configuration, and the entire apparatus is controlled as a whole by a system controller 52B which is similar to the system controller 52A. Various values to be used for controlling various parts of the camera apparatus 51B such as values representing optical characteristics of an ND filter 22B are stored in a non-volatile memory provided in the system controller 52B.

The system controllers 52A and 52B are connected through a predetermined connection cable to transmit and receive various types of information and control commands to and from each other through an internal communication interface.

When the power supplies of the system controllers 52A and 52B connected as thus described are turned on, a mutual communication process is performed to decide the controller to serve as a main controller for controlling the system as a whole.

The system controller whose ND filter reduces a greater or smaller amount of light or the system controller having a smaller or greater production number may be chosen as the main controller. Alternatively, the main controller may be decided based on an operation or instruction of a user. The following description is based on an assumption that the system controller 52A is chosen as the main controller.

The system controller 52A includes functional blocks similar to those of the system controller 2 (FIG. 2) of the first embodiment such as an overall control section 41, a filter driving control section 42, a diaphragm control section 43, a shutter speed control section 44, and an amplification gain control section 45.

In the present embodiment, the system controller 52A serving as the main controller first acquires various values to be used for controlling various parts of the camera apparatus 51B (e.g., values representing optical characteristics of the ND filter 22B) from the system controller 52B.

Subsequently, the overall control section 41 sets an exposure value of the compound eye imaging system 50 as a whole and determines whether to inset or remove ND filters 22A and 22B, aperture values of diaphragms 23A and 23B, shutter speeds of imaging devices 24A and 24B, and gains of amplification at analog signal processing sections 25A and 25B.

The filter driving control section 42, the diaphragm control section 43, the shutter speed control section 44, and the amplification gain control section 45 generate filter driving signals DFA and DFB, diaphragm driving signals DDA and DDB, shutter speed signals DSA and DSB, and amplification gain signals DGA and DGB, respectively, like comparable features of the first embodiment.

The system controller 52B relays each of the filter driving signal DFB, the diaphragm driving signal DDB, the shutter speed signal DSB, and the amplification gain signal DGB generated by the system controller 52A.

As thus described, the system controller 52A of the second embodiment determines an exposure value of the entire system and determines whether to insert or remove the ND filters. The controller generates control signals for various parts of the camera apparatus 51A and 51B and supplies them to those parts respectively.

### [2-2. Control Over Amount of Light Reduction]

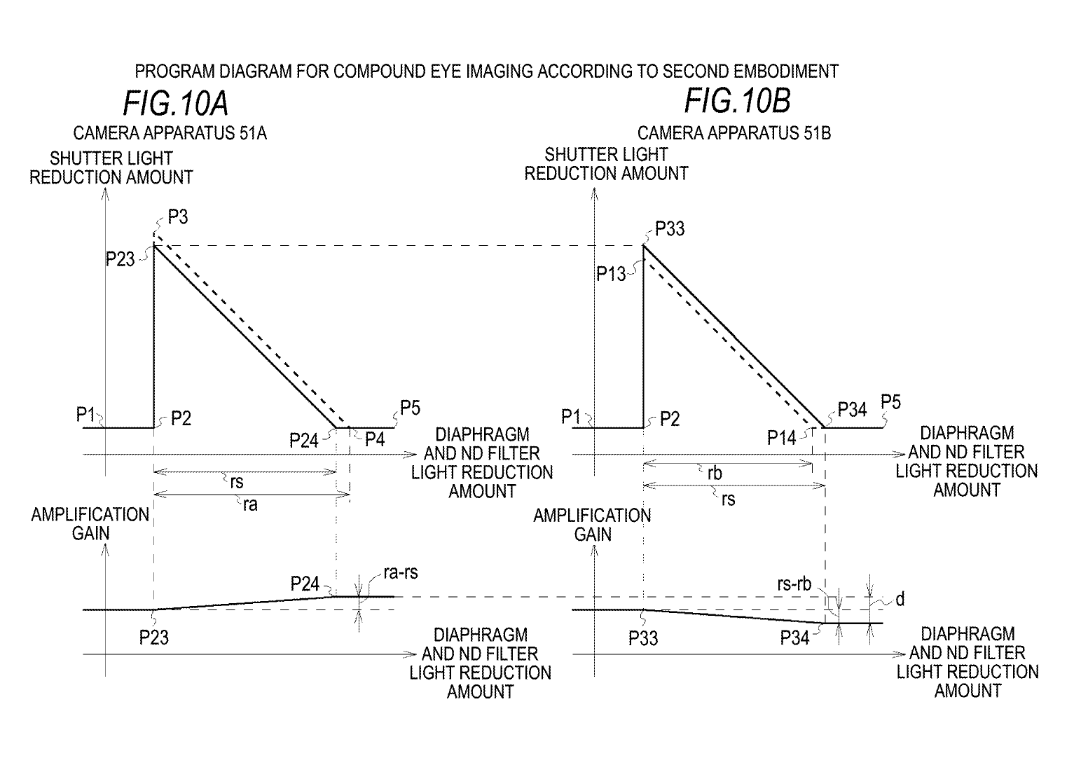

In the second embodiment of the present disclosure, as will be apparent from FIGS. 10A and 10B which correspond to FIGS. 6A and 6B, corrections are made to both of program diagrams to be followed by the camera apparatus 51A and 51B, respectively, instead of correcting either one of the program diagrams.

A reference light reduction amount rs defined in advance based on a standard value or a design center value of the amount of light reduced by ND filters is stored in a non-volatile memory provided in the system controller 52A.

The following description is based on an assumption that a relationship “ra>rs>rb” holds true between a light reduction amount ra of the ND filter 22A, the reference light reduction amount rs, and a light reduction amount rb of the ND filter 22B.

A program diagram for the camera apparatus 51A is corrected such that the bent line extends through points P23 and P24 adjusted to the reference light reduction amount rs instead of points P3 and P4 which are based on the light reduction amount ra of the ND filter 22A, as shown in the top part of FIG. 10A.

The embodiment is similar to the first embodiment in that an additional program diagram representing the gain of amplification at the analog signal processing section 25A is provided for the camera apparatus 51A, as shown in the bottom part of FIG. 10A.

The additional program diagram indicates that the gain of amplification is gradually increased (i.e., the amount of light reduction attributable to the gain of amplification is gradually decreased) when the ND filter 22A is gradually inserted into the optical path of the imaging light because the light reduction amount ra is greater than the reference light reduction amount rs.

In other words, according to the program diagram shown in FIG. 10A, the amount of light (ra-rs) reduced by the ND filter 22A in the excess of the reference light reduction amount rs is cancelled by the reduction in the light reduction amount attributable to the gain of amplification.

As shown in the top part of FIG. 10B, a program diagram for the camera apparatus 51B is corrected such that the bent line extends through points P33 and P34 which are adjusted according to the reference light reduction amount rs instead of the points P13 and P14 which are based on the light reduction amount rb of the ND filter 22B.

The camera apparatus 51B is similar to the camera apparatus 51A in that it follows an additional program diagram representing the gain of amplification at the analog signal processing section 25B as shown in the bottom part of FIG. 10B.

The additional program diagram indicates that the gain of amplification is gradually decreased (i.e., the amount of light reduction attributable to the gain of amplification is gradually increased) when the ND filter 22B is gradually inserted into the optical path of imaging light because the light reduction amount rb is smaller than the reference light reduction amount rs.

In other words, according to the program diagrams shown in FIG. 10B, a shortage in light reduction (rs-rb) attributable to the light reduction amount of the ND filter 22B which is smaller than the reference light reduction amount rs is cancelled by an increase in the amount of light reduction attributable to the gain of amplification.

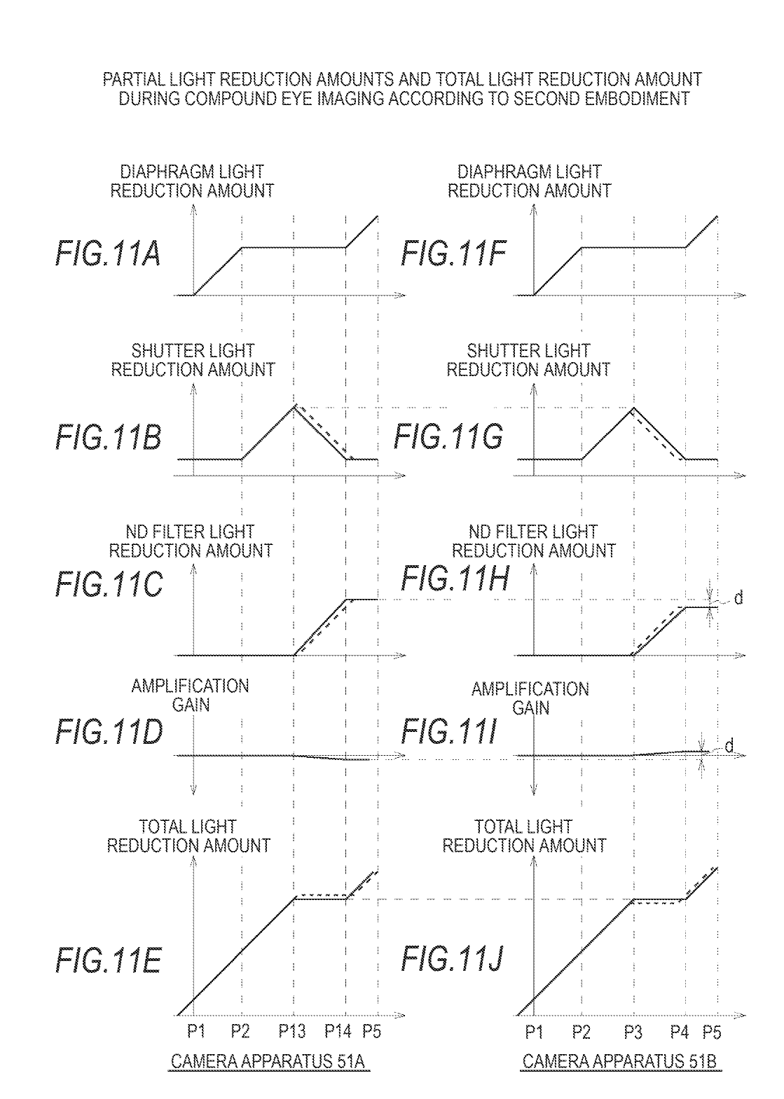

FIGS. 11A to 11E corresponds to FIGS. 7A to 7E, and the figures show amounts of light reduced at the camera apparatus 51A, i.e., amounts of light reduced by the shutter, the diaphragm, and the ND filter of the camera apparatus, an amount of light reduction attributable to the gain of amplification, and a total amount of light reduction at the apparatus in association with points on the program diagram shown in FIG. 10A.

FIGS. 11F to 11J correspond to FIGS. 7F to 7J, and the figures show amounts of light reduced at the camera apparatus 51B, i.e., amounts of light reduced by the shutter, the diaphragm, and the ND filter of the camera apparatus, an amount of light reduction attributable to the gain of amplification, and a total amount of light reduction at the apparatus in association with points on the program diagram shown in FIG. 10B.

In practice, when an amount of light reduction associated with a video signal V5A is to be continuously increased, the system controller 52A controls various amounts of light reduction as shown in FIGS. 11A to 11E according to the program diagrams shown in FIG. 10A.

At this time, the system controller 52A controls the various amounts of light reduction according to a processing routine similar to the light reduction increasing control routine RT2 shown in FIG. 8.

When an amount of light reduction associated with a video signal V5B is to be continuously increased in parallel with the above-described operation, the system controller 52A controls various amounts of light reduction as shown in FIGS. 11F to 11J through the system controller 52B, according to the program diagrams shown in FIG. 10B.

The system controller 52A controls the various amounts of light reduction according to a processing routine similar to the light reduction increasing control routine RT2 shown in FIG. 8. In this case, however, the amount of light reduction attributable to the gain of amplification is increased at step SP13.

As thus described, the system controller 52A controls various parts of the camera apparatus 51A whose ND filter 22A has the light reduction amount ra greater than the reference light reduction amount rs such that the amount of light reduced by the shutter is adjusted according to the reference light reduction amount rs and such that the excess of the light reduction amount ra over the reference light reduction amount rs (ra-rs) is cancelled by the light increase amount attributable to the gain of amplification.

The system controller 52A controls various parts of the camera apparatus 51B whose ND filter 22B has the light reduction amount rb smaller than the reference light reduction amount rs such that the amount of light reduced by the shutter is adjusted according to the reference light reduction amount rs and such that the shortage of the light reduction amount rb below the reference light reduction amount rs (rs-rb) is cancelled by the light reduction amount attributable to the gain of amplification.

Thus, the system controller 52A is always capable of making the total amounts of light reduced at the camera apparatus 51A and 51B equal to each other.

Alternatively, the system controller 52A may transmit only a reference light reduction amount rs of the entire system to the system controller 52B, and the system controller 52B may control the amount of light reduced at each part of the camera apparatus 51B with a difference of such an amount from the reference light reduction amount rs taken into account. Since the reference light reduction amount rs of the entire system is the only information to be communicated, various loads associated with communication can be significantly reduced.

### [2-3. Operations and Effects]

In the above-described configuration, when compound eye imaging is performed by the camera apparatus 51A and 51B of the compound eye imaging system 50 in communication with each other, the system controller 52A of the camera apparatus 51A exercises control such that the amount of light reduced by each part of the system is adjusted according to a predetermined reference value instead of an optimal value for the part.

Specifically, the system controller 52A controls each part of the camera apparatus 51A according to a corrected program diagram (FIG. 10A) such that the amount of light reduced by the diaphragm 23A and the amount of light reduced by the shutter of the imaging device 24A are adjusted according to the reference light reduction amount rs (FIGS. 11A and 11B).

The system controller 52A exercises control to increase the amount of light reduced by the ND filter 22A gradually and to increase the gain of amplification at the analog signal processing section 25A gradually, i.e., to decrease the amount of light reduction attributable to the gain of amplification gradually (FIGS. 11C and 11D).

The system controller 52A controls the camera apparatus 51B according to a corrected program diagram (FIG. 10B) such that the amount of light reduced by the diaphragm 23B and the amount of light reduced by the shutter of the imaging device 24B are adjusted according to the reference light reduction amount rs (FIGS. 11F and 11G).

The system controller 52A exercises control to increase the amount of light reduced by the ND filter 22B gradually and to decrease the gain of amplification at the analog signal processing section 25B gradually, i.e., to increase the amount of light reduction attributable to the gain of amplification gradually (FIGS. 11H and 11I).

As a result, when increasing the amount of light reduction, the system controller 52A can make the total amounts of light reduction at the camera apparatus 51A and 51B equal to each other while making the shutter speeds and the aperture values of the apparatus completely equal to each other and also making the degrees of insertion of the ND filters 22A and 22B completely equal to each other, just as done in the first embodiment of the present disclosure.

In the present embodiment, the gains of amplification at the analog signal processing sections 25A and 25B are corrected in the direction of increasing or decreasing the same based on differences between the light reduction amounts ra and rb of the ND filters 22A and 22B and the reference light reduction amount rs which is a design center value of the filters.

In the present embodiment, therefore, the width of correction of the gain of amplification at each of the camera apparatus 51A and 51B can be made smaller than that in the first embodiment. It is therefore possible to suppress a change in image quality attributable to fluctuations of optimal gains of amplification.

In the present embodiment, program diagrams are corrected based on respective differences between the amounts of light reduced by the ND filters 22A and 22B and the reference light reduction amount rs instead of a difference between the amounts of light reduced by the ND filters 22A and 22B.

The corrected program diagrams (FIGS. 10A and 10B) may be stored in advance in a non-volatile memory or the like, for example, at a stage of manufacture such as assembly or adjustment of the camera apparatus 51A and 51B.

In this case, since the system controller 52A can use the corrected program diagrams stored as thus described as they are, there is no need for performing a process of correcting program diagrams each time the camera apparatus are connected based on a difference between the amounts of light reduced by ND filters thereof.

The compound eye imaging system 50 of the present embodiment can provide other advantages similar to the advantages of the compound eye imaging system 1 of the first embodiment.

In the above-described configuration, the system controller 52A of the camera apparatus 51A of the compound eye imaging system 50 controls various parts of the camera apparatus 51A and 51B such that the amounts of light reduced by the diaphragms and the shutters of the apparatus are adjusted to the reference light reduction amount rs according to the corrected program diagrams. The system controller 52A exercises control to increase the amount reduced by the ND filter 22A gradually and to increase the gain of amplification at the analog signal processing section 25A gradually. The controller also exercises control to increase the amount reduced by the ND filter 22B gradually and to decrease the gain of amplification at the analog signal processing section 25B gradually. As a result, the system controller 52A can make the total amounts of light reduction at the camera apparatus 51A and 51B equal to each other while making the shutter speeds and the aperture values of the camera apparatus completely equal to each other and also making the degrees of insertion of the ND filters 22A and 22B completely equal to each other, in the same manner as in the first embodiment.

### 3. Other Embodiments

In the first embodiment of the present disclosure, control is exercised such that the gain of amplification at the imaging unit 3A whose ND filter 22A reduces a greater amount of light is increased as the ND filter 22A is inserted according to a corrected program diagram.

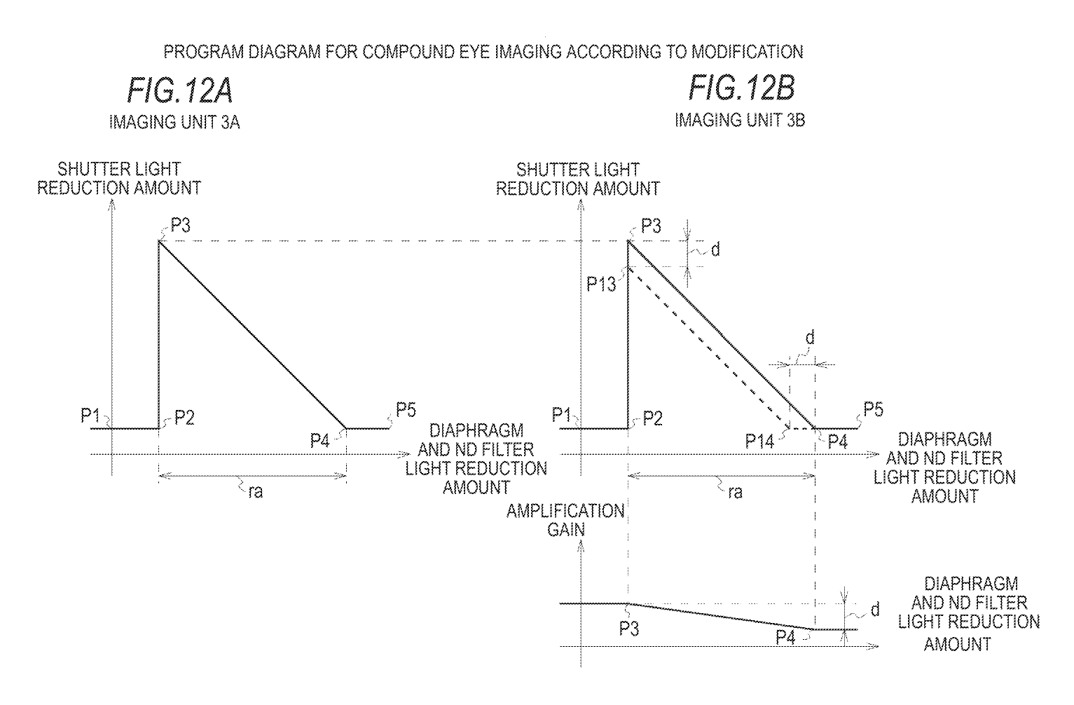

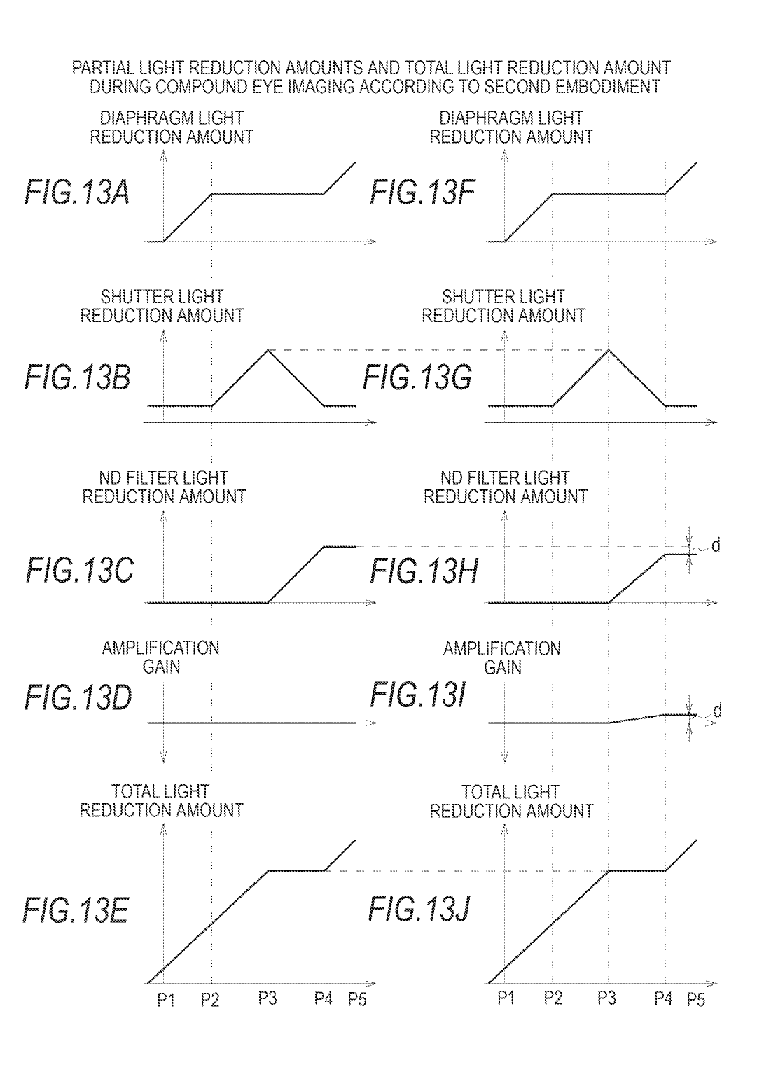

The present disclosure is not limited to such a mode of implementation. For example, control may alternatively be exercised such that the gain of amplification at the imaging unit 3B whose ND filter 22B reduces a smaller amount of light is decreased as the ND filter 22B is inserted according to a corrected program diagram, as shown in FIGS. 12A and 12B and FIGS. 13A to 13J corresponding to FIGS. 6A and 6B and FIGS. 7A to 7J.

When controlling amounts of light reduction during compound eye imaging, what is required for the system controller 2 is only to cancel any difference between the optical characteristics of the ND filters by changing the gain of amplification while making the imaging units 3A and 3B equal to each other in terms of the aperture value, the shutter speed, and the degree of insertion of the ND filter according to a program diagram corrected to be followed by either of the imaging units.

According to the above description of the first embodiment of the present disclosure, the section between the points P13 and P14 on the program diagram associated with the gain of amplification (shown in the bottom part of FIG. 6B) is straight.

The present disclosure is not limited to such a shape of the section, and the section may be plotted, for example, in the form of a curved or bent line based on results of actual measurement of changes in the amount of light during the gradual insertion of the ND filter 22A into the optical path or theoretical values of such changes obtained through calculations. This holds true for the second embodiment of the present disclosure.

According to the above description of the second embodiment of the present disclosure, various parts of the camera apparatus 51A and 51B are controlled according to the respective programs corrected according to the reference light reduction amount rs which is determined in advance.

The present disclosure is not limited to such a mode of implementation. For example, an average light reduction amount may alternatively be calculated by averaging the light reduction amount ra of the ND filter 22A and the light reduction amount rb of the ND filter 22B, and various parts of the camera apparatus 51A and 51B may be controlled with their respective program diagrams corrected according to the average light reduction amount.

In this case, since the widths of fluctuations of the gains of amplification at the camera apparatus 51A and 51B can be made equal to each other, it is possible to eliminate the risk of a difference in quality between images obtained by the apparatus attributable to a difference between the widths of fluctuations of the gains of amplification.

According to the above description of the first embodiment of the present disclosure, when the amount of light reduction is increased using an ND filter, the amount of light reduced by a shutter is temporarily increased, and the gain of amplification is changed as the ND filter is thereafter inserted while decreasing the amount of light reduced by the shutter, according to the program diagrams (FIG. 6A).

The present disclosure is not limited to such a mode of implementation, and control may be exercised such that the gain of amplification is changed depending only on the degree of insertion or removal of the ND filter instead of changing the gain in conjunction with the amount of light reduced by the shutter. This holds true for the second embodiment of the present disclosure.

According to the above description of the first embodiment of the present disclosure, control is exercised such that the amounts of light reduced at various parts of the system are changed according to the same program diagrams whether the total light reduction amount is increased or decreased.

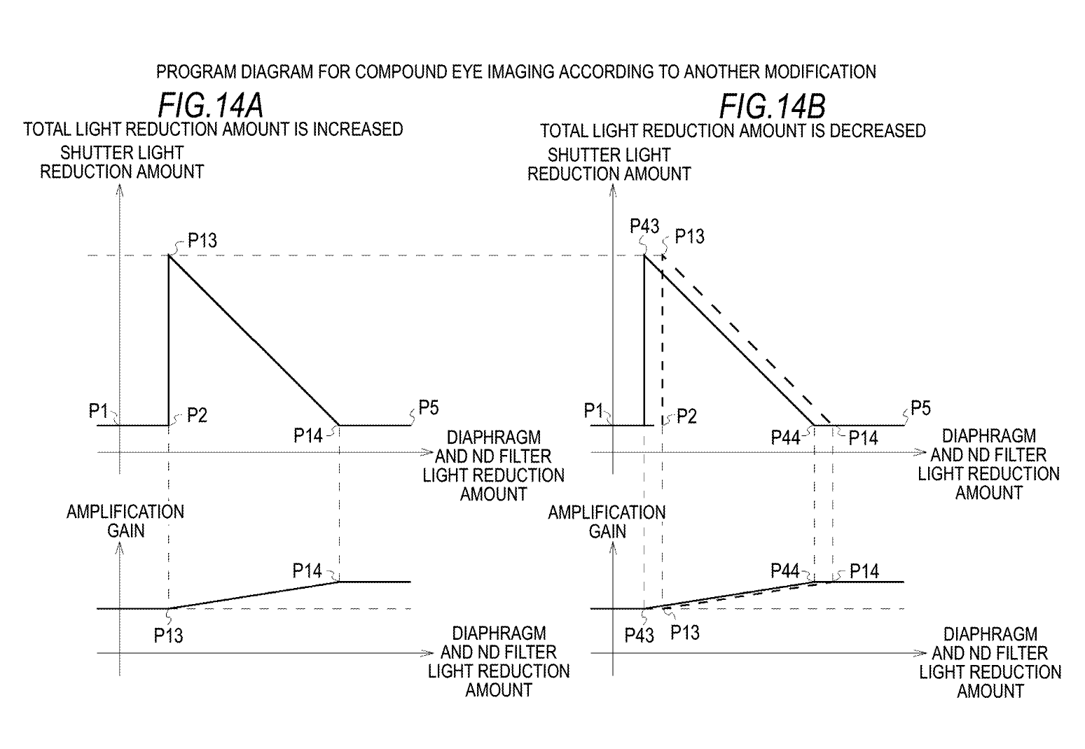

The present disclosure is not limited to such a mode of implementation. For example, various parts of the imaging unit 3A may alternatively be controlled such that different program diagrams are followed when increasing and decreasing the total light reduction amount or such that hysteresis will be added as shown in FIGS. 14A and 14B which correspond to FIG. 6A. Specifically, when decreasing the total light reduction amount (FIG. 14B), control is exercised to follow a program diagram extending through points P44 and P43 representing light reduction amounts smaller than comparable amounts in the case wherein the total light reduction amount is increased (represented by a broken line in the figure).

When hysteresis exits in the directions of increasing and decreasing amounts of light reduced, it is possible to prevent the ND filters from being frequently inserted and removed during imaging. This holds true for the second embodiment of the present disclosure.

Further, according to the above description of the first embodiment of the present disclosure, the gain of amplification at the analog signal processing section 25 is controlled such that it changes according to a program diagram.

The present disclosure is not limited to such a mode of implementation. For example, the gain may alternatively be controlled by various processing blocks such as the digital signal processing section 27A capable of adjusting the gain of a video signal whether the signal is analog or digital such that the gain changes according to the degree of insertion or removal of the ND filter. This holds true for the second embodiment of the present disclosure.

According to the above description of the first embodiment of the present disclosure, when an independent system controller 2 is used, control is exercised by the system controller 2 such that the gain of amplification of one of the imaging units, e.g., only the imaging unit 3A is changed by correcting the program diagram for the imaging unit.

The present disclosure is not limited to such a mode of implementation. For example, control may be exercised by the independent system controller 2 such that the gains of amplification at the imaging units 3A and 3B are changed according to respective program diagrams corrected according to a reference light reduction amount rs in the same manner as in the second embodiment of the present disclosure.

According to the above description of the second embodiment of the present disclosure, only the camera apparatus 51A and 51B are connected to each other, the system controller 52A controls both of the camera apparatus 51A and 51B such that the gains of amplification at the camera apparatus are changed according to respective program diagrams corrected according to a reference light reduction amount rs.

The present disclosure is not limited to such a mode of implementation. For example, when only the camera apparatus 51A and 51B are connected to each other, one of the camera apparatus, e.g., only the camera apparatus 51A may be controlled such that the gain of amplification at the camera apparatus is changed by correcting the program diagram associated therewith, in the same manner as in the first embodiment.

According to the above description of the second embodiment of the present disclosure, various functional blocks such as the overall control section 41 and the filter driving control section 42 (FIG. 2) are provided only in the system controller 52A.

The present disclosure is not limited to such a mode of implementation. For example, the filter driving control section 42 may be provided in the system controller 52B such that the filter control signal DFA is relayed by the system controller 52A to be supplied to the ND filter driver 32A. Alternatively, the filter driving control section 42 may be provided in both of the system controllers 52A and 52B respectively to generate the filter control signal DFA and DFB at each of the controllers.

According to the above description of the first embodiment of the present disclosure, the two imaging units 3A and 3B are used to generate two systems of video signals, i.e., the video signals V5A and V5B.

The present disclosure is not limited to such a mode of implementation. For example, the present disclosed technique may be applied to imaging to obtain a holographic image. Specifically, the present disclosed technique may be applied to imaging of a holographic image performed by generating a plurality of video signals of an object to be imaged simultaneously in parallel using a plurality (an arbitrary number such as 3 or 8) of imaging units 3.

In this case, control may be exercised using the imaging unit 3 whose ND filter 22 reduces the smallest or the greatest amount of light as a reference according to which program diagrams of the other imaging units are to be corrected and the gains of amplification at the other imaging units are to be changed. Alternatively, an average value or center value of the amounts of light reduced by the ND filters 22 may be calculated, and control may be exercised such that each program diagram is corrected according to the average value or center value and such that each gain of amplification is changed according to the average value or center value.

According to the above description of the first embodiment of the present disclosure, the light reduction amount control program is stored in the non-volatile memory 14 in advance, and the program is read and executed to control various parts of the system to change the gain of amplification according to the degree of insertion or removal of the ND filters.

The present disclosure is not limited to such a mode of implementation. For example, the light reduction amount control program may alternatively be executed by acquiring it from an external server apparatus or host apparatus connected through a USB (universal serial bus) or LAN (local area network). This holds true for the second embodiment of the present disclosure.

According to the above description of the first embodiment of the present disclosure, the system controller 2 serving as an imaging control device is constituted by the filter driving control section 42 and the amplification gain control section 45.

The present disclosure is not limited to such a mode of implementation, and an imaging control device may be constituted by a filter driving control section, and an amplification gain control section having any other configuration.

According to the above description of the second embodiment of the present disclosure, the compound eye imaging system 50 is constituted as an imaging apparatus by the imaging units 3A and 3B as imaging sections, the filter driving control section 42, and the amplification gain control section 45.

The present disclosure is not limited to such a mode of implementation, and an imaging apparatus may be constituted by imaging sections, a filter driving control section, and an amplification gain control section having any other configuration.

The present disclosed technique may be used in various types of video cameras capable of compound eye imaging for business and home use, digital still cameras and mobile phones having a motion picture shooting function, and computer apparatus.

The present disclosure contains subject matter related to that disclosed in Japanese Priority Patent Application JP 2010-293358 filed in the Japan Patent Office on Dec. 28, 2010, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

1. An imaging control device configured to control first and second imaging sections each generating an imaging signal based at least in part on an imaging light incident thereon using an imaging device and each having a filter for reducing an amount of the imaging light, the imaging control device comprising:
a filter driving control section configured to control each of filter driving sections configured to insert or remove filters of the first and second imaging sections, respectively, into and from an optical path of the imaging light such that the filter driving section performs a filter inserting or removing operation over a predetermined period of operation; and
an amplification gain control section configured to act on each of signal processing sections configured to amplify the imaging signals at the first and second imaging sections, respectively, such that a gain of amplification of the imaging signal is controlled by a width of adjustment according to a difference between amounts of light reduced by a plurality of the filters of a plurality of the imaging sections in conjunction with the operation of inserting or removing the filters.

2. An imaging control device according to claim 1, wherein the amplification gain control section configured to act on either of the first imaging section and the second imaging section to control the gain of amplification at the signal processing section by the width of adjustment according to the difference between the amounts of light reduced.

3. An imaging control device according to claim 2, wherein the amplification gain control section is configured to control either of the first imaging section and the second imaging section, whichever has the filter reducing a greater amount of light, such that the gain of amplification at the signal processing section is increased by the width of adjustment according to the difference between the amounts of light reduced.

4. An imaging control device according to claim 2, wherein the amplification gain control section is configured to control either of the first imaging section and the second imaging section whichever has the filter reducing a smaller amount of light, such that the gain of amplification at the signal processing section is decreased by the width of adjustment according to the difference between the amounts of light reduced.

5. An imaging control device according to claim 1, wherein the amplification gain control section is configured to act on each of the first imaging section and the second imaging section to control the gain of amplification at the signal processing section such that a brightness of the imaging signal is adjusted to a predetermined reference value when the filter is inserted in the optical path.

6. An imaging control device according to claim 5, wherein the predetermined reference value is a center value or an average value of the brightness of the imaging signals measured when the filters are inserted in the optical paths of each of the first imaging section and the second imaging section.

7. An imaging control device according to claim 1, further comprising:
a shutter speed control section configured to control a shutter speed of the imaging device; and
a diaphragm control section configured to control a diaphragm for limiting the imaging light, wherein
the shutter speed control section is configured to control the filter inserting operation such that a light reduction amount attributable to the shutter speed is increased in advance by an equivalent light reduction amount which is equivalent to the amount of light reduced by the filter prior to the filter inserting operation and such that the shutter speed of the imaging device is thereafter decreased by the equivalent light reduction amount over the predetermined period of operation in conjunction with the filter inserting operation and configured to control the filter removing operation such that the shutter speed of the imaging device is increased over the predetermined period of operation to achieve the equivalent light reduction amount in conjunction with the removing operation and such that the light reduction amount attributable to the shutter speed is thereafter decreased by the equivalent light reduction amount; and
the diaphragm control section is configured to exercise control such that the diaphragm is fixed during the period of operation.

8. An imaging control device according to claim 7, wherein the shutter speed control section is configured to control the shutter speed such that a width of fluctuation of the light reduction amount attributable to the shutter speed at either of the first imaging section and the second imaging section whichever has the filter reducing a greater amount of light is set at another light reduction amount which is equivalent to the amount of light reduced by the filter of the other imaging section; and
the amplification gain control section is configured to control either of the first imaging section and the second imaging section whichever has the filter reducing a greater amount of light such that the gain of amplification at the signal processing section is increased by the width of adjustment according to the difference between the amounts of light reduced.

9. An imaging control device according to claim 7, wherein the shutter speed control section is configured to control the shutter speed such that the width of fluctuation of the light reduction amount attributable to the shutter speed at either of the first imaging section and the second imaging section whichever has the filter reducing a smaller amount of light is set at another light reduction amount which is equivalent to the amount of light reduced by the filter of the other imaging section; and
the amplification gain control section is configured to control either of the first imaging section and the second imaging section whichever has the filter reducing a smaller amount of light such that the gain of amplification at the signal processing section is decreased by the width of adjustment according to the difference between the amounts of light reduced.

10. An imaging control method for controlling first and second imaging sections each generating an imaging signal based at least in part on an imaging light incident thereon using an imaging device and each having a filter for attenuating imaging light, the imaging control method comprising:
controlling each of filter driving sections configured to insert or remove filters of the first and second imaging sections, respectively, into and from an optical path of the imaging light such that the filter driving section performs the filter inserting or removing operation over a predetermined period of operation; and
acting on each of signal processing sections configured to amplify the imaging signals at the first and second imaging sections, respectively, such that a gain of amplification of the imaging signal is controlled over the period of operation by a width of adjustment according to a difference between amounts of light reduced by a plurality of the filters of a plurality of the imaging sections in conjunction with the operation of inserting or removing the filters.

11. An imaging control program for causing an imaging control device to exercise control over first and second imaging sections each generating an imaging signal based at least in part on an imaging light incident thereon using an imaging device and each having a filter for attenuating the imaging light, the control comprising:
controlling each of filter driving sections configured to insert or remove filters of the first and second imaging sections, respectively, into and from the optical path of an imaging light such that the filter driving section performs the filter inserting or removing operation over a predetermined period of operation; and
acting on each of signal processing sections configured to amplify the imaging signals at the first and second imaging sections, respectively, such that a gain of amplification of the imaging signal is controlled over the period of operation by a width of adjustment according to a difference between amounts of light reduced by a plurality of the filters of a plurality of the imaging sections in conjunction with the operation of inserting or removing the filters.

12. An imaging apparatus comprising:
first and second imaging sections each configured to generate an imaging signal based at least in part on an imaging light incident thereon using an imaging device and each having a filter for attenuating the imaging light;
a filter driving control section controlling each of filter driving sections configured to insert or remove filters of the first and second imaging sections, respectively, into and from an optical path of the imaging light such that the filter driving section performs the filter inserting or removing operation over a predetermined period of operation; and
an amplification gain control section acting on each of signal processing sections configured to amplify the imaging signals at the first and second imaging sections, respectively, such that a gain of amplification of the imaging signal is controlled by a width of adjustment according to a difference between amounts of light reduced by a plurality of the filters of a plurality of the imaging sections in conjunction with the operation of inserting or removing the filters.
